(19) United States
(12) Patent Application Publication
(10) Pub. No.: US 2025/0312778 A1
(43) Pub. Date: Oct. 9, 2025

(54) TERNARY PLATINUM ALLOYS WITH TRANSITION METALS FOR ENHANCED OXIDATION ACTIVITY

(71) Applicants: BASF CORPORATION, Florham Park, NJ (US); THE RESEARCH FOUNDATION FOR THE STATE UNIVERSITY OF NEW YORK, Albany (NY)

(72) Inventors: Xinyi WEI, Iselin, NJ (US); Yuejin LI, Iselin, NJ (US); Chuan-Jian ZHONG, Binghamton, NY (US); Shiyao SHAN, Binghamton, NY (US); Shan WANG, Binghamton, NY (US)

(21) Appl. No.: 18/873,049

(22) PCT Filed: Jun. 9, 2023
(86) PCT No.: PCT/EP2023/065478

§ 371 Date: Dec. 9, 2024

(30) Foreign Application Priority Data
Jun. 10, 2022 (EP) 22178511.6

(51) Int. Cl. B01J 23/89; B01D 53/94; B01J 35/45; B01J 37/08; F01N 3/035; F01N 3/10; F01N 3/20

(52) U.S. Cl. CPC B01J 23/8986; B01D 53/9418; B01D 53/945; B01J 35/45; B01J 37/086; F01N 3/035; F01N 3/101; F01N 3/2066; B01D 2255/1021; B01D 2255/2073; B01D 2255/20738; B01D 2255/20746; B01D 2255/20753; B01D 2257/404; B01D 2257/502; B01D 2257/702; B01D 2258/012; B01J 2235/15; B01J 2235/30; F01N 2250/02; F01N 2370/02

(57) ABSTRACT

Disclosed herein are oxidation catalysts, oxidation catalyst composites, systems, and methods for treating exhaust gas streams to control the emission of hydrocarbons (HC), carbon monoxide (CO), and nitrogen oxides (NOₓ) in the exhaust gas stream of internal combustion engines. The oxidation catalysts, oxidation catalyst composites, systems and methods of treating comprise a ternary alloy nanoparticle catalyst; the ternary alloy nanoparticle catalyst comprises a platinum group metal alloyed with at least two transition metal elements.

This disclosure was made with government support under CHE-2102482 awarded by the National Science Foundation. The government has certain rights in the disclosure.

The present disclosure is directed to oxidation catalysts, systems, and methods for treating exhaust gas streams to control the emission of hydrocarbons (HC), carbon monoxide (CO), and nitrogen oxides (NOₓ) in the exhaust gas stream of internal combustion engines. The oxidation catalysts, systems and methods of treating comprise a ternary alloy nanoparticle catalyst; the ternary alloy nanoparticle catalyst comprises a platinum group metal alloyed with at least two transition metal elements.

Exhaust gas streams of internal combustion engines contain pollutants such as hydrocarbons (HC), carbon monoxide (CO) and nitrogen oxides (NOₓ) that foul the air. Generally, oxidation catalysts comprising a precious metal, such as platinum group metals (PGMs), dispersed on a refractory metal oxide support, such as alumina, are used in treating the exhaust of internal combustion engines in order to convert both HC and CO gaseous pollutants by catalyzing the oxidation of these pollutants to carbon dioxide and water. Typically, the oxidation catalysts are formed on ceramic or metallic substrates upon which one or more catalyst coating compositions are deposited. In addition to the conversion of gaseous HC and CO emissions, oxidation catalysts that contain PGM promote the oxidation of NO to NO₂, which enhances downstream SCR reactions, particularly at lower temperature (≤250° C.).

Catalysts are typically defined by their light-off temperature or the temperature at which 50% conversion is attained, also called T₅₀. Catalysts containing only platinum become less active with use and particularly after hydrothermal aging, for instance, resulting in reduced NO₂ generation from NO oxidation, which in turn results in lower downstream SCR activity, most pronounced at lower temperature (≤250° C.). Large changes in NO₂/NOₓ ratios from fresh to aged catalysts also lead to complexity in calibrating the urea injection rate in the course of catalyst deactivation as a result of hydrothermal aging.

Oxidation catalysts comprising a precious metal dispersed on a refractory metal oxide support are known for use in treating the exhaust of diesel engines to convert both hydrocarbon and carbon monoxide gaseous pollutants by catalyzing the oxidation of these pollutants to carbon dioxide and water. Such catalysts have been generally contained in units called diesel oxidation catalysts (DOC), or more simply catalytic converters, which are placed in the exhaust flow path from a Diesel-powered engine to treat the exhaust before it vents to the atmosphere. Typically, the diesel oxidation catalysts are formed on ceramic or metallic substrate carriers (such as the flow-through monolith carrier, as described herein below) upon which one or more catalyst coating compositions are deposited. In addition to the conversions of gaseous HC, CO and particulate matter, oxidation catalysts that contain platinum group metals (which are typically dispersed on a refractory oxide support) promote the oxidation of nitric oxide (NO) to NO₂.

One important factor in DOC design is catalyst-deactivation following high temperature exposure. Thermally induced DOC deactivation can occur as a result of sintering of the catalytic component or carrier. Sintering of the catalytic component involves coalescence or crystallite growth of catalytic sites, which are initially well-dispersed. This aggregation results in a loss of surface to volume ratio, reducing catalytic performance. Alternatively, exposure of the DOC to high temperatures can result in sintering of the catalytic carrier. This involves a loss of the carrier pore structure that causes loss of accessibility to catalytic active sites.

S. Shiyao et al., “Surface oxygenation of multicomponent nanoparticles toward active and stable oxidation catalysts”, NATURE COMMUNICATIONS, vo. 11, no.1, Dec. 1, 2020, relates to the synthesis of oxidation catalysts for total oxidation of hydrocarbons, e.g., propane, by surface oxygenation of platinum-alloyed multicomponent nanoparticles.

L. Yang et al., “Role of Support-Nanoalloy Interactions in the Atomic-Scale Structural and Chemical Ordering for Tuning Catalytic Sites”, JOURNAL OF THE AMERICAN CHEMICAL SOCIETY, vo. 134, no. 36, Sep. 12, 2012, discloses alloy nanoparticles as an oxidation catalyst, which may be supported on silica, titania or carbon, wherein the catalyst is employed for the oxidation of CO.

Thus, there remains a need for still more efficient catalysts for the treatment of exhaust gases of internal combustion engines. A specific need includes a catalyst that provides excellent conversion of CO, HC, and NOΔNO₂ oxidation and that is stable to hydrothermal aging.

The present disclosure is directed to oxidation catalysts which are ternary alloy nanoparticle catalysts. The ternary alloy nanoparticle catalyst comprise a platinum group metal that is alloyed with at least two transition metal elements. The platinum group metal may be chosen from Pt, Pd, Ru, Rh, Ir, and Os; and the at least two transition metal elements may be chosen from Ni, Co, Mn, Fe, V, Zn, Cu, Ti, Sc, and Cr. The present disclosure is further directed to a diesel oxidation catalyst comprising the above ternary alloy nanoparticle catalyst.

The ternary alloy nanoparticle catalyst may be supported on a refractory oxide support, and the refractory oxide support may be chosen from silica, δ-alumina, θ-alumina, γ-alumina, Si-doped alumina, alkaline earth metal-stabilized alumina, transition metal-stabilized alumina, zirconia, and titania.

The platinum group metal content of the ternary alloy nanoparticle may be less than or equal to about 80 atom % of the metal content, and the platinum group metal weight ratio may be about 30 atom % to about 50 atom % of the metal content.

The at least two transition metal elements of the ternary alloy nanoparticle may have a combined ratio of about 20 atom % to about 80 atom % of the metal content.

The platinum group metal and the at least two transition metal elements of the ternary alloy nanoparticle catalyst may be detectable by TEM/EDS (Transmission Electron Microscopy coupled with Energy Dispersive X-ray Spectroscopy), X-Ray Diffractometry, or a combination thereof.

The XRD of the ternary alloy nanoparticle may exhibit 2theta values for Pt fcc (111) ranging from about 39.7° to about 42° upon incorporation of different levels of the at least two transition metals.

The ternary alloy nanoparticle catalyst may be chosen from PtNiCo and PtMnFe. The atomic ratio of the PtNiCo ternary alloy nanoparticle catalyst may be about 20-80% Pt, about 1-50% Ni, and about 5-40% Co. The atomic ratio of the PtMnFe ternary alloy nanoparticle catalyst may be about 15-40% Pt, about 10-50% Mn, and about 10-50% Fe.

The present disclosure also provides for a process for preparing a ternary alloy nanoparticle catalyst comprising a platinum group metal alloyed with at least two transition metal elements. The process may include combining a precursor of the platinum group metal and precursors of the at least two transition metal elements with a capping agent in an organic solvent to form a solution; introducing a reducing agent to the solution to produce a colloidal suspension of the ternary alloy nanoparticle catalyst; collecting and adsorbing the ternary alloy nanoparticle catalyst onto a refractory oxide support; and drying and calcining the adsorbed ternary alloy nanoparticle catalyst and refractory oxide support.

The precursor of the platinum group metal may be chosen from platinum(II) acetylacetonate, chloroplatinic acid, platinum(II) hydroxysulfite acid, tetraammine platinum(II) chloride, and tetraamine platinum(II) nitrate. The precursors of the at least two transition metal elements maybe chosen from nickel(II) acetylacetonate and cobalt(III) acetylacetonate. The capping agent may be chosen from citric acid, polyvinylpyrrolidone, oleylamine, oleic acid, and polyethylene glycol. The reducing agent may be chosen from sodium borohydride, hydrazine, formic acid, sodium formate, and an amine-borane complex; 1, 2-hexadecanediol and oleylamine. The refractory oxide support may be chosen from silica, δ-alumina, θ-alumina, γ-alumina, Si-doped alumina, alkaline earth metal-stabilized alumina, transition metal-stabilized alumina, zirconia, and titania.

The calcining step of the process may comprise calcining the ternary alloy nanoparticle catalyst and refractory oxide support at about 800° C. under a hydrogen atmosphere for about 2 hours, followed by heating at about 260° C. in air for about 1 hour, and heating at about 590° C. in air for about 1 hour.

The nanoparticles of the ternary alloy catalyst may have an average particle size ranging from about 2 nm to about 10 nm.

The total platinum group metal content of the ternary alloy nanoparticle catalyst may be about 0.1 wt % to about 5 wt % of the metal content.

The nanoparticles of the ternary alloy catalyst generally retain the original atom ratio of individual elements. Although transition metal elements are present throughout the entire nanoparticle, enrichment is often found on the particle surface, likely due to the oxyphilic nature of transition metals upon being calcined in air.

After hydrothermal aging, the nanoparticles of the ternary alloy catalyst become much more enriched in Pt composition (>90 atom %), the transition metal elements become <10 atom %. All three elements appear uniformly throughout the particles.

The present disclosure further provides for an exhaust gas treatment system comprising the ternary alloy nanoparticle catalyst as described herein, preferably comprising the oxidation catalyst composite according to any of the particular and preferred embodiments described herein. The ternary alloy nanoparticle catalyst may be positioned downstream of and in fluid communication with an internal combustion engine.

The present disclosure also provides for a method of treating an exhaust gas stream comprising HC and/or CO and/or NO→NO₂ oxidation. The method may comprise passing the exhaust gas stream through a ternary alloy nanoparticle catalyst or an oxidation catalyst composite or an exhaust gas treatment system as described herein.

### BRIEF DESCRIPTION OF THE FIGURES

In order to provide an understanding of the embodiments of the present disclosure, reference is made to the appended figures. The figures are exemplary and should not be construed at limiting the disclosure.

FIG. 1 shows transmission electron microscopy (TEM) images of (A) Example 1 (Pt₄₁Ni₃₆CO₂₃), (B) Comparative Example 3 (Pt₅₁Ni₄₉), (C) Comparative Example 4 (Pt₆₃CO₃₇), and (D) Example 3 (Pt₄₁Ni₃₆Co₂₃ dispersed on γ-Al₂O₃, at ˜0.72 wt % Pt).

FIG. 2 shows TEM images of Example 2 at various Pt/Mn/Fe atom ratios: (A) Pt₁₃Mn₂₇Fe₆₀, (B) Pt₃₈Mn₂₉Fe₃₃, (C) Pt₈₆Mn₁Fe₁₃, and Example 4 (D) Pt₃₈Mn₂₉Fe₃₃/Al₂O₃ at ˜0.53 wt % Pt.

FIG. 3 shows X-ray diffraction patterns of Example 1 (isolated PtNiCo), Comparative Example 1 (10 wt % Pt/Al₂O₃), and Example 3 (PtNiCo/Al₂O₃ at 10 wt % Pt).

FIG. 4 is an elemental line profile of nanoparticles in Example 3 after 650° C./50 h HT aging (PtNiCo/Al₂O₃, ˜0.72% Pt).

FIG. 5 shows a comparison of NO→NO₂ activity between Example 3 and Comparative Example 1 before and after 650° C./50 h aging, and the test was conducted according to Example 5.

FIG. 6 is a comparison of change in NO₂/NOₓ ratio (ΔNO₂/NOₓ, difference between fresh and aged) for Example 3 (Pt₅₅Ni₂₇Co₁₈/Al₂O₃) vs Comparative Examples 1 and 2, where all samples contain 1.85% Pt, and were aged 650° C./50 h, and the test was conducted according to Example 5.

FIG. 7 is a comparison of CO & HC light-off T₅₀ for Example 3 (Pt₅₅Ni₂₇CO₁₈/Al₂O₃) vs Comparative Example 1 and Comparative Example 2, wherein all samples contain 1.85% Pt, were aged at 650° C./50 h, and the test was conducted according to Example 5.

FIG. 8 shows the effect of Pt/Ni/Co atom ratio on the stability of NO₂/NOₓ ratio from fresh to aged (650° C./50 h), where the test was conducted according to Example 5 after 650° C./50 h hydrothermal aging.

FIG. 9 shows the effect of Pt/Ni/Co atom ratio on the stability of NO₂/NOₓ ratio from fresh to aged (675° C./25 h), where the test was conducted according to Example 6 after 675° C./25 h aging.

FIG. 10 shows a comparison of NO light-off activity of Comparative Example 6 (Pt₄₄Ni₅₆/Al₂O₃, ˜1.1 wt % Pt) and Comparative Example 7 (Pt₄₀Co₆₀/Al₂O₃, ˜0.59 wt % Pt) vs Comparative Example 1 (˜1 wt % Pt) before and after aging (675° C./25 h), and the test was conducted according to Example 6.

FIG. 11 shows the comparison of NO light-off activity of Example 4 (Pt₃₇Mn₅₀Fe₁₃/Al₂O₃, ˜0.64 wt % Pt) and Comparative Example 2 (0.7 wt % Pt), before and after aging (650° C./50 h), and the test was conducted according to Example 5.

FIG. 12 shows the comparison of NO light-off activity of Comparative Example 5 (Pt₄₆Mn₅₄/Al₂O₃, ˜1 wt % Pt) and Comparative Example 1, where both were fresh samples, and the test was conducted according to Example 6.

FIG. 13 shows a comparison of CO-DRIFTS (Diffuse Reflectance Infrared Fourier Transform Spectroscopy) intensity between Comparative Examples 1 and 2 and Example 3 (Pt₅₅Ni₂₇Co₁₈ atom ratio) before and after hydrothermal aging (650° C./50 h). All samples contain 1.85 wt % Pt. CO adsorption experiments were conducted after pretreatment in Ar at 400° C. for 1 hour and the figure insert shows expanded signals of aged samples.

The present disclosure will now be described more fully. However, the disclosure may be embodied in many different forms and should both be construed as limited to the embodiments set forth herein.

As used herein, “a” or “an” entity refers to one or more of that entity, e.g., “a catalyst” refers to one or more catalysts or at least one catalyst unless stated otherwise. As such, the terms “a” (or “an”), “one or more”, and “at least one” are used interchangeably herein.

As used herein, the term “about” means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%.

As used herein, the term “alloy” refers to material consisting of two or more metal elements combined through atomic bonding. Properties exhibited by alloys of the present disclosure are different from the individual properties of the elements making up the alloy. Distribution of each element in the alloy can be affected by external treatment, resulting in enrichment of certain elements, often found on the particle surface.

As used herein, the term “stream” broadly refers to any combination of flowing gas that may contain solid or liquid particulate matter. The term “gaseous stream” or “exhaust stream” or “exhaust gas stream” means a stream of gaseous constituents, such as the exhaust of a combustion engine, which may contain entrained non-gaseous components such as liquid droplets, solid particulates, and the like. The exhaust gas stream of a combustion engine typically further comprises combustion products (CO₂ and H₂O), products of incomplete combustion (carbon monoxide (CO) and hydrocarbons (HC)), oxides of nitrogen (NOₓ), combustible and/or carbonaceous particulate matter (soot), and unreacted oxygen and nitrogen.

As used herein, “impregnated” or “impregnation” refers to permeation of the catalytic material into the porous structure of the support material.

The present catalysts are suitable for treatment of exhaust gas streams of internal combustion engines, for example gasoline, light-duty diesel, and heavy-duty diesel engines. In some embodiments, such catalysts can be combined with other components, e.g., with other catalyst compositions to provide compositions and articles suitable for use as diesel oxidation catalysts or catalyzed soot filters. The catalysts are also suitable for treatment of emissions from stationary industrial processes, removal of noxious or toxic substances from indoor air or for catalysis in chemical reaction processes.

The present disclosure is directed to a ternary alloy nanoparticle catalyst comprising a platinum group metal alloyed with at least two transition metal elements. In some embodiments, the ternary alloy nanoparticle catalyst comprises of two transition metal elements. In some embodiments, the ternary alloy nanoparticle catalyst comprises three transition metal elements. In some embodiments, the ternary alloy nanoparticle catalyst comprises four transition metal elements.

As used herein, the term “platinum group metal” (PGM) refers to a platinum group metal or an oxide thereof, such as, e.g., platinum (Pt), palladium (Pd), ruthenium (Ru), rhodium (Rh), osmium (Os), iridium (Ir), an oxide of any of the foregoing, and mixtures of any of the foregoing. In some embodiments, the PGM may be in any valence state.

In some embodiments, the platinum group metal of the ternary alloy nanoparticle catalyst is chosen from Pt, Pd, Ru, Rh, Ir, and Os. In some embodiments, the platinum group metal of the ternary alloy nanoparticle catalyst is Pt. In some embodiments, the platinum group metal of the ternary alloy nanoparticle catalyst is Pd. In some embodiments, the platinum group metal of the ternary alloy nanoparticle catalyst is a combination of Pt and Pd. In some embodiments, the platinum group metal of the ternary alloy nanoparticle catalyst is Ru. In some embodiments, the platinum group metal of the ternary alloy nanoparticle catalyst is Rh. In some embodiments, the platinum group metal of the ternary alloy nanoparticle catalyst is chosen from Ir. In some embodiments, the platinum group metal of the ternary alloy nanoparticle catalyst is Os.

In some embodiments, the at least two transition metals of the ternary alloy nanoparticle catalyst are chosen from nickel (Ni), cobalt (Co), manganese (Mn), iron (Fe), vanadium (V), zinc (Zn), copper (Cu), titanium (Ti), scandium (Sc), and chromium (Cr). In some embodiments, the at least two transition metals are Ni and Co. In some embodiments, the at least two transition metals are Ni and Mn. In some embodiments, the at least two transition metals are Ni and Fe. In some embodiments, the at least two transition metals are Ni and V. In some embodiments, the at least two transition metals are Ni and Zn. In some embodiments, the at least two transition metals are Ni and Cu. In some embodiments, the at least two transition metals are Ni and Ti. In some embodiments, the at least two transition metals are Ni and Sc. In some embodiments, the at least two transition metals are Ni and Cr. In some embodiments, the at least two transition metals are Co and Mn. In some embodiments, the at least two transition metals are Co and Fe. In some embodiments, the at least two transition metals are Co and V. In some embodiments, the at least two transition metals are Co and Zn. In some embodiments, the at least two transition metals are Co and Cu. In some embodiments, the at least two transition metals are Co and Ti. In some embodiments, the at least two transition metals are Co and Sc. In some embodiments, the at least two transition metals are Co and Cr. In some embodiments, the at least two transition metals are Mn and Fe. In some embodiments, the at least two transition metals are Mn and V. In some embodiments, the at least two transition metals are Mn and Zn. In some embodiments, the at least two transition metals are Mn and Cu. In some embodiments, the at least two transition metals are Mn and Ti. In some embodiments, the at least two transition metals are Mn and Sc. In some embodiments, the at least two transition metals are Mn and Cr. In some embodiments, the at least two transition metals are Fe and V. In some embodiments, the at least two transition metals are Fe and Zn. In some embodiments, the at least two transition metals are Fe and Cu. In some embodiments, the at least two transition metals are Fe and Ti. In some embodiments, the at least two transition metals are Fe and Sc. In some embodiments, the at least two transition metals are Fe and Cr. In some embodiments, the at least two transition metals are V and Zn. In some embodiments, the at least two transition metals are V and Cu. In some embodiments, the at least two transition metals are V and Ti. In some embodiments, the at least two transition metals are V and Sc. In some embodiments, the at least two transition metals are V and Cr. In some embodiments, the at least two transition metals are Zn and Cu. In some embodiments, the at least two transition metals are Zn and Ti. In some embodiments, the at least two transition metals are Zn and Sc. In some embodiments, the at least two transition metals are Zn and Cr. In some embodiments, the at least two transition metals are Cu and Ti. In some embodiments, the at least two transition metals are Cu and Sc. In some embodiments, the at least two transition metals are Cu and Cr. In some embodiments, the at least two transition metals are Ti and Sc. In some embodiments, the at least two transition metals are Ti and Cr. In some embodiments, the at least two transition metals are Sc and Cr.

In some embodiments, the ternary alloy nanoparticle catalyst is supported on a refractory oxide support chosen from silica, δ-alumina, θ-alumina, γ-alumina, Si-doped alumina, alkaline earth metal-stabilized alumina, transition metal-stabilized alumina, zirconia, and titania. In some embodiments, the refractory oxide support is silica. In some embodiments, the refractory oxide support is δ-alumina. In some embodiments, the refractory oxide support is θ-alumina. In some embodiments, the refractory oxide support is γ-alumina. In some embodiments, the refractory oxide support is Si-doped alumina. In some embodiments the Si-doped alumina contains SiO₂ in a range of about 1% to about 20%. In some embodiments the Si-doped alumina contains about 1% SiO₂. In some embodiments the Si-doped alumina contains about 5% SiO₂. In some embodiments the Si-doped alumina contains about 10% SiO₂. In some embodiments the Si-doped alumina contains about 15% SiO₂. In some embodiments the Si-doped alumina contains about 20% SiO₂. In some embodiments, the refractory oxide support is an alkaline earth metal-stabilized alumina. In some embodiments, the alkaline earth-stabilized alumina is Mn-stabilized alumina. In some embodiments, the refractory oxide support is a transition metal-stabilized alumina. In some embodiments, the transition metal stabilized alumina is Zr-doped alumina. In some embodiments, the transition metal stabilized alumina is Ti-doped alumina. In some embodiments, the refractory oxide support is zirconia. In some embodiments, the refractory oxide support is titania.

In some embodiments, the platinum group metal content of the ternary alloy nanoparticle catalyst is less than or equal to about 80 atom % of the metal content. In some embodiments, the platinum group metal content is about 20 atom % of the metal content. In some embodiments, the platinum group metal content is about 25 atom % of the metal content. In some embodiments, the platinum group metal content is about 30 atom % of the metal content. In some embodiments, the platinum group metal content is about 35 atom % of the metal content. In some embodiments, the platinum group metal content is about 40 atom % of the metal content. In some embodiments, the platinum group metal content is about 45 atom % of the metal content. In some embodiments, the platinum group metal content is about 50 atom % of the metal content. In some embodiments, the platinum group metal content is about 55 atom % of the metal content. In some embodiments, the platinum group metal content is about 60 atom % of the metal content. In some embodiments, the platinum group metal content is about 65 atom % of the metal content. In some embodiments, the platinum group metal content is about 70 atom % of the metal content. In some embodiments, the platinum group metal content is about 75 atom % of the metal content. In some embodiments, the platinum group metal content is about 80 atom % of the metal content.

In some embodiments, the platinum group metal ratio of the ternary alloy nanoparticle catalyst is about 30 atom % to about 50 atom % of the metal content. In some embodiments, the platinum group metal weight ratio is about 30 atom % of the metal content. In some embodiments, the platinum group metal weight ratio is about 35 atom % of the metal content. In some embodiments, the platinum group metal weight ratio is about 40 atom % of the metal content. In some embodiments, the platinum group metal weight ratio is about 45 atom % of the metal content. In some embodiments, the platinum group metal weight ratio is about 50 atom % of the metal content.

In some embodiments, the at least two transition metal elements of ternary alloy nanoparticle catalyst have a combined ratio of about 20 atom % to about 80 atom % of the metal content. In some embodiments, the at least two transition metal elements have a combined weight ratio of about 20 atom % of the metal content. In some embodiments, the at least two transition metal elements have a combined weight ratio of about 25 atom % of the metal content. In some embodiments, the at least two transition metal elements have a combined weight ratio of about 30 atom % of the metal content. In some embodiments, the at least two transition metal elements have a combined weight ratio of about 35 atom % of the metal content. In some embodiments, the at least two transition metal elements have a combined weight ratio of about 40 atom % of the metal content. In some embodiments, the at least two transition metal elements have a combined weight ratio of about 45 atom % of the metal content. In some embodiments, the at least two transition metal elements have a combined weight ratio of about 50 atom % of the metal content. In some embodiments, the at least two transition metal elements have a combined weight ratio of about 55 atom % of the metal content. In some embodiments, the at least two transition metal elements have a combined weight ratio of about 60 atom % of the metal content. In some embodiments, the at least two transition metal elements have a combined weight ratio of about 65 atom % of the metal content. In some embodiments, the at least two transition metal elements have a combined weight ratio of about 70 atom % of the metal content. In some embodiments, the at least two transition metal elements have a combined weight ratio of about 75 atom % of the metal content. In some embodiments, the at least two transition metal elements have a combined weight ratio of about 80 atom % of the metal content.

In some embodiments, the platinum group metal and the at least two transition metal elements of the ternary alloy nanoparticle catalyst are detectable by TEM/EDS. In some embodiments, the platinum group metal and the at least two transition metal elements of the ternary alloy nanoparticle catalyst are detectable by X-Ray Diffractometry. In some embodiments, the XRD exhibits 2theta values for Pt fcc (111) in the range of about 39.7° to about 42° upon incorporation of different levels of the at least two transition metals.

In some embodiments, the ternary alloy nanoparticle catalyst is PtNiCo. In some embodiments, the atomic ratio of the PtNiCo ternary alloy nanoparticle catalyst is about 20%-80% Pt, about 1%-50% Ni, and about 5%-40% Co. In some embodiments, the atomic ratio is about 30%-60% Pt, about 20%-40% Ni, and about 10%-30% Co.

In some embodiments, the ternary alloy nanoparticle catalyst is PtMnFe. In some embodiments, the atomic ratio of the PtMnFe ternary alloy nanoparticle catalyst is about 15%-40% Pt, about 10%-50% Mn, and about 10%-50% Fe. In some embodiments, the atomic ratio is about 30%-40% Pt, about 30%-40% Mn, and about 30%-40% Fe.

In some embodiments, an oxidation catalyst composite for abatement of exhaust gas emissions from a lean burn engine is provided, comprising the above ternary alloy nanoparticle catalyst. In some embodiments, the lean burn engine is a lean-burn gasoline engine or a diesel engine, preferably a diesel engine.

In some embodiments, the oxidation catalyst composite comprises:
a carrier substrate having a length, an inlet end and an outlet end, and
an oxidation catalyst catalytic material comprising the ternary alloy nanoparticle catalyst,
wherein the oxidation catalyst catalytic material is provided on the carrier substrate.

In some embodiments, the oxidation catalyst catalytic material comprises, preferably consists of, a washcoat layer comprising the ternary alloy nanoparticle catalyst. In some embodiments, the washcoat layer comprises a zeolite.

In some embodiments, the washcoat layer comprises from 5 to 500 g/ft³ of platinum group metal, calculated as the element, from the ternary alloy nanoparticle catalyst, preferably from 10 to 300 g/ft³, more preferably from 20 to 200 g/ft³, more preferably from 40 to 150 g/ft³, more preferably from 60 to 120 g/ft³, more preferably from 80 to 100 g/ft³. In some embodiments, the oxidation catalyst catalytic material comprises, preferably consists of, a bottom washcoat layer and a top washcoat layer, wherein the bottom washcoat layer is provided on the carrier substrate and the top washcoat layer is provided on the bottom washcoat layer. In some embodiments, the bottom washcoat layer, the top washcoat layer, or both the bottom and the top washcoat layers comprise the ternary alloy nanoparticle catalyst.

In some embodiments, the bottom washcoat layer or the top washcoat layer comprise the ternary alloy nanoparticle catalyst, wherein the bottom or top washcoat layer comprises from 5 to 500 g/ft³ of platinum group metal, calculated as the element, from the ternary alloy nanoparticle catalyst, preferably from 10 to 300 g/ft³, more preferably from 20 to 200 g/ft³, more preferably from 40 to 150 g/ft³, more preferably from 60 to 120 g/ft³, more preferably from 80 to 100 g/ft³.

In some embodiments, the bottom and top washcoat layers comprise the ternary alloy nanoparticle catalyst, wherein the total amount of platinum group metal in the bottom and top washcoat layers, calculated as the element, from the ternary alloy nanoparticle catalyst comprised in the bottom and top washcoat layers is in the range of from 5 to 500 g/ft³, preferably from 10 to 300 g/ft³, more preferably from 20 to 200 g/ft³, more preferably from 40 to 150 g/ft³, more preferably from 60 to 120 g/ft³, more preferably from 80 to 100 g/ft³.

In some embodiments, the top washcoat layer or the bottom washcoat layer comprises a zeolite, wherein preferably the top washcoat layer comprises a zeolite. In some embodiments, the top washcoat layer comprises a zeolite and the bottom washcoat layer is substantially free of zeolite. In some embodiments, the bottom washcoat layer comprises a zeolite and the top washcoat layer is substantially free of zeolite. Within the meaning of the present invention, “substantially free” means that the washcoat layer contains less than 1 wt.-% of zeolite, preferably less than 0.5 wt.-%, more preferably less than 0.1 wt,-%, more preferably less than 0.05 wt,-%, more preferably less than 0.01 wt,-%, more preferably less than 0.005 wt,-%, more preferably less than 0.001 wt,-%.

In some embodiments, the washcoat layer or the washcoat layers comprising the ternary alloy nanoparticle catalyst is substantially free of barium, wherein preferably the washcoat layer or the washcoat layers comprising the ternary alloy nanoparticle catalyst is substantially free of alkaline earth metal. Within the meaning of the present invention, “substantially free” means that the washcoat layer contains less than 1 wt.-% of barium or alkaline earth metal calculated as the respective element, preferably less than 0.5 wt.-%, more preferably less than 0.1 wt,-%, more preferably less than 0.05 wt,-%, more preferably less than 0.01 wt,-%, more preferably less than 0.005 wt,-%, more preferably less than 0.001 wt,-%. In some embodiments, the carrier substrate is a wall-flow substrate or a flow-through substrate, preferably a flow-through substrate, more preferably a honeycomb monolith substrate.

The present disclosure also related to a process for preparing a ternary alloy nanoparticle catalyst comprising a platinum group metal alloyed with at least two transition metal elements. For example, the present disclosure is directed to a process for preparing a ternary alloy nanoparticle catalyst comprising a platinum group metal alloyed with at least two transition metal elements, the process comprising: (a) combining a salt of the platinum group metal and salts of the at least two transition metal elements with a capping agent in an organic solvent to form a slurry; (b) introducing a reducing agent to the slurry to produce a colloidal suspension of the ternary alloy nanoparticle catalyst; (c) collecting and adsorbing the ternary alloy nanoparticle catalyst onto a refractory oxide support; and (d) drying and calcining the adsorbed ternary alloy nanoparticle catalyst and refractory oxide support.

In some embodiments, the process comprises (a) combining a precursor of the platinum group metal and precursors of the two transition metal elements with a capping agent in an organic solvent to form a solution. In some embodiments, the precursor of the platinum group metal is platinum(II) acetylacetonate. In some embodiments, the precursor of the platinum group metal is chloroplatinic acid. In some embodiments, the precursor of the platinum group metal is platinum(II) hydroxysulfite acid. In some embodiments, the precursor of the platinum group metal is tetraammine platinum(II) chloride. In some embodiments, the precursor of the platinum group metal is tetraamine platinum(II) nitrate. In some embodiments, the precursors of the at least two transition metal elements are nickel(II) acetylacetonate and cobalt(III) acetylacetonate. In some embodiments, the capping agent is citric acid. In some embodiments, the capping agent is polyvinylpyrrolidone. In some embodiments, the capping agent is oleylamine. In some embodiments, the capping agent is oleic acid. In some embodiments, the capping agent is polyethylene glycol.

In some embodiments, the process comprises (b) introducing a reducing agent to the solution to produce a colloidal suspension of the ternary alloy nanoparticle catalyst. In some embodiments, the reducing agent is sodium borohydride. In some embodiments, the reducing agent is hydrazine. In some embodiments, the reducing agent is formic acid. In some embodiments, the reducing agent is sodium formate. In some embodiments, the reducing agent is an amine-borane complex. In some embodiments, the reducing agent is 1, 2-hexadecanediol. In some embodiments, the reducing agent is s oleylamine.

In some embodiments, the process comprises (c) collecting and adsorbing the ternary alloy nanoparticle catalyst onto a refractory oxide support. In some embodiments, the process comprises (d) drying and calcining the adsorbed ternary alloy nanoparticle catalyst and refractory oxide support. In some embodiments, the calcining step comprises calcining the ternary alloy nanoparticle catalyst and refractory oxide support at about 800° C. under a hydrogen atmosphere for about 2 hours, followed by heating at about 260° C. in air for about 1 hour, and heating at about 590° C. in air for about 1 hour.

In some embodiments, the nanoparticles of the ternary alloy nanoparticle catalyst have an average particle size of about 2 nm to about 10 nm when supported on an inorganic refractory oxide. In some embodiments, the nanoparticles of the ternary alloy nanoparticle catalyst have an average particle size of about 2 nm to about 5 nm. In some embodiments, the nanoparticles have an average particle size of about 2 nm. In some embodiments, the nanoparticles have an average particle size of about 3 nm. In some embodiments, the nanoparticles have an average particle size of about 4 nm. In some embodiments, the nanoparticles have an average particle size of about 5 nm.

As used herein, the term “particle size” refers to the smallest diameter sphere that will completely enclose the particle, and this measurement relates to an individual particle as opposed to an agglomeration of two or more particles. Particle size may be measured by laser light scattering techniques, with dispersions or dry powders, e.g., according to ASTM method D4464. Particle size may also be measured by Scanning Electron Microscopy (SEM) or Transmission Electron Microscopy (TEM) for submicron size particles, or by a particle size analyzer for support-containing particles (micron size). In addition to TEM, carbon monoxide (CO) chemisorption may be used to determine average PGM particle size. This technique does not differentiate between various PGM species (e.g., Pt, Pd, etc., as compared to XRD, TEM, and SEM) and only determines the average particle size.

In some embodiments, the total platinum group metal content of the ternary alloy nanoparticle catalyst is about 0.1 wt % to about 5 wt % of the metal content. In some embodiments, the total platinum group metal content of the ternary alloy nanoparticle catalyst is about 0.5 wt % to about 2 wt % of the metal content. In some embodiments, the total platinum group metal content is about 0.5 wt % of the metal content. In some embodiments, the total platinum group metal content is about 1.0 wt % of the metal content. In some embodiments, the total platinum group metal content is about 1.5 wt % of the metal content. In some embodiments, the total platinum group metal content is about 2 wt % of the metal content. In some embodiments, the total platinum group metal content is about 2.5 wt % of the metal content. In some embodiments, the total platinum group metal content is about 3 wt % of the metal content. In some embodiments, the total platinum group metal content is about 3.5 wt % of the metal content. In some embodiments, the total platinum group metal content is about 4 wt % of the metal content. In some embodiments, the total platinum group metal content is about 4.5 wt % of the metal content. In some embodiments, the total platinum group metal content is about 5 wt % of the metal content.

In another aspect of the present disclosure, there is provided an exhaust gas treatment system comprising the ternary alloy nanoparticle catalyst of any one of the preceding embodiments, positioned downstream of and in fluid communication with an internal combustion engine.

In some embodiments, the internal combustion engine is a lean burn engine, preferably a lean-burn gasoline engine or a diesel engine, preferably a diesel engine. In some embodiments, the exhaust gas treatment system is in fluid communication with the internal combustion engine via an exhaust conduit.

In some embodiments, the exhaust gas treatment system further comprises a catalyzed soot filter and/or an SCR catalyst component containing an SCR catalyst composition, preferably a catalyzed soot filter and an SCR catalyst component containing an SCR catalyst composition.

In some embodiments, the catalyzed soot filter and/or the SCR catalyst component are located downstream of the ternary alloy nanoparticle catalyst, preferably of the oxidation catalyst composite, wherein more preferably both the catalyzed soot filter and the SCR catalyst component are located downstream of the ternary alloy nanoparticle catalyst, preferably of the oxidation catalyst composite.

In yet another aspect of the present disclosure there is provided a method of treating an exhaust gas stream comprising hydrocarbons and/or carbon monoxide and/or NOₓ, the method comprising passing the exhaust gas stream through the ternary alloy nanoparticle catalyst or an exhaust gas treatment system of any one of the preceding embodiments.

### EXAMPLES

### Comparative Example 1

A Pt reference sample was prepared via incipient wetness impregnation. A support material such as alumina was impregnated with a Pt ammine precursor solution, followed with drying at 110° C. and calcination at 590° C.

### Comparative Example 2

A Pt reference sample was prepared in a similar manner to that of Comparative Example 1, except that a colloidal Pt precursor with 1-3 nm average Pt particle size was used.

### Example 1

The synthesis of PtNiCo nanoparticles (NPs) involved the reduction and decomposition of three metal precursors, Pt^{II}(acac)₂, Ni^{II}(acac)₂, and Co^{III}(acac)₃, in controlled molar ratios in a dioctyl ether solvent at an elevated temperature. For the synthesis of Pt₄₁Ni₃₆Co₂₃ nanoparticles, 397 mg Pt^{II}(acac)₂, 256 mg Ni^{II}(acac)₂, and 356 mg Co^{III}(acac)₃, were dissolved in 100 ml dioctyl ether at room temperature, followed by the addition of 1.0 ml oleylamine, 1.0 ml oleic acid, and 1.000 g 1,2-hexanedecandiol. The mixture was purged with N₂ gas to eliminate ambient air before the temperature was raised in stages to 105° C. for 20 minutes, then 180° C. for another 20 mins until it became completely dark brown. The temperature was finally raised to 270° C. and refluxed for 40 mins. After it was cooled down to room temperature, the resulting solution was diluted with ethanol at a volume ratio 1:2.5. After crystallization overnight (˜12 hours), the supernatant was discarded, and the remaining precipitation was dried by purging with N₂ gas for 10 minutes. The precipitated black powders were re-dispersed in hexane solution before further use.

### Comparative Example 3

A colloidal Pt₅₁Ni₄₉ solution was prepared in a similar manner to that used in Example 1, except that a Co precursor was not added.

### Comparative Example 4

A colloidal Pt₆₂Co₃₈ solution was prepared in a similar matter to that used in Example 1, except that a Ni precursor was not added.

### Example 2

A colloidal Pt₃₃Mn₃₄Fe₃₃ solution was prepared in a similar matter to that used in Example 1, and Pt^{II}(acac)₂, Mn₂(CO)₁₀, and Fe(CO)₅ were precursors employed in controlled molar ratio.

### Comparative Example 5

A Pt₄₆Mn₅₄/Al₂O₃ sample was prepared via a one-pot synthesis. A controlled molar ratio of Pt^{II}(acac)₂, and Mn^{II}(acac)₂, with Al₂O₃ supports were first suspended in DMF solvent before being transferred to a Teflon autoclave to undergo reaction for 12 hours. The resulting powders were cleaned by ethanol and filtrated before calcination at 590° C. in air for one hour.

### Example 3

A supported PtNiCo catalyst on alumina was prepared by adding a colloidal PtNiCo solution (10-20 mg/ml hexane)—Example 1 to an inorganic carrier material (0.5-10 g) suspended in 5-30 mL of pre-mixed isopropanol/hexane (1:9 volume ratio) solution. The mixture was sonicated for 20 minutes then purged with N₂ to remove the solvent. The dried fine powder was then subjected to calcination at 800° C. under an H₂ atmosphere for 2 hours followed by successive calcination at 260° C. in air for 1 hour and then again at 590° C. for 1 hour. This protocol resulted in all samples maintaining virtually the same trimetallic composition with a slight enrichment of Pt % than that of nanoparticle precursors.

### Comparative Example 6

A supported Pt₅₁Ni₄₉/Al₂O₃ catalyst was prepared in a similar manner to that used in Example 3, except that a colloidal PtNi solution—Comparative Example 3 was used.

### Comparative Example 7

A supported Pt₆₃Co₃₇/Al₂O₃ catalyst was prepared in a similar manner to that used in Example 3, except that a colloidal PtCo—Comparative Example 4 solution was used.

### Example 4

A supported Pt₃₇Mn₅₀Fe₁₃/Al₂O₃ catalyst was prepared in a similar manner to that used in Example 3, except that a colloidal PtMnFe solution—Example 2 was used.

### Example 5 (High Throughput Powder Testing)

Powder catalysts were crushed and sieved to 250-500 μm size range, and 100 mg was diluted with corundum to ˜1 mL volume. Samples were loaded on a high throughput testing unit, and each sample was tested at 125° C., 135° C., 150° C., 165° C., 180° C., 195° C., 210° C., 225° C., 250° C., and 300° C. The feed gas composition was 500 ppm NO, 300 ppm CO, 40 ppm propene, 60 ppm-C1 HC (toluene/decane=½ on C1 basis), 10% O₂, 10% CO₂, and 10% H₂O, the space velocity (simulating 1 mL of coated catalyst) was 45000/h.

### Example 6 (Single Powder Testing)

Powder catalysts were sieved to 200-500 μm, and 30 mg sample was tested in simulated exhaust gas mixture of 200 ppm NO+167 ppm C₃H₆+333 ppm CO+10% O₂+10% H₂O+balanced by N₂) at a flow rate 250 ml/min.

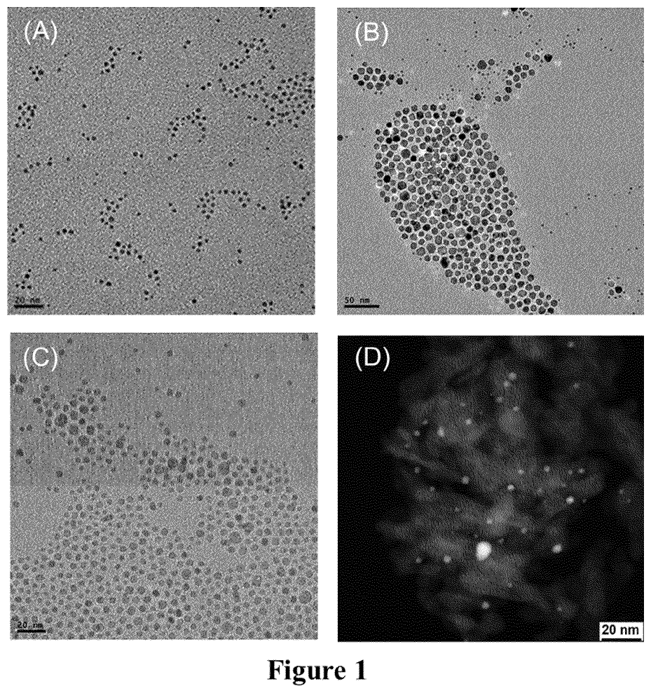

FIG. 1 shows a comparison of the sizes of synthesized PtNiCo [(Fig. 1A) and (FIG. 1D)], PtNi (FIG. 1B), and PtCo (FIG. 1C) nanoparticles. Ternary alloy Example 1 (Pt₄₁Ni₃₆Co₂₃) showed the smallest particle size average of 2.9-3.6 nm. Bimetallic alloy Comparative Example 3 (Pt₄₅Ni₅₅) and Comparative Example 4 (Pt₆₃Co₃₇) appeared in sizes of 9-10 nm and 4-5 nm, respectively. Once deposited on alumina [Example 3, Pt₄₁Ni₃₆Co₂₃/Al₂O₃ (FIG. 1D)], some larger PtNiCo nanoparticles appeared, with increased size ranges of 2 nm-10 nm.

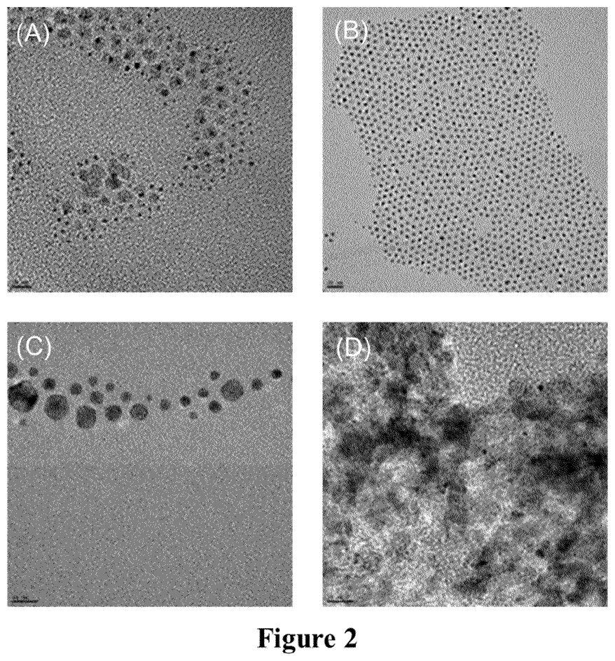

FIG. 2 shows the effect of Pt/Mn/Fe ratio on the size of nanoparticles. Pt₁₃Mn₂₇Fe₆₀ NPs (FIG. 2A) show a mixture of small particles at an average size of 2.8±0.6 nm and large nanoparticles at 6.4±1.7 nm in diameter. FIG. 2B shows a representative image of Pt₃₈Mn₂₉Fe₃₃ nanoparticles with an average size of about 4.0±0.5 nm, while the average size of Pt₈₆Mn₁Fe₁₃ nanoparticles was estimated to be ˜6.1±1.0 nm in FIG. 2C. These results suggest that particle size and morphology are highly dependent on the metallic composition. Smallest particles are found at an intermediate Pt level of ˜40 atom % Pt. FIG. 2D shows the size of Al₂O₃ supported Pt₃₈Mn₂₉Fe₃₃ alloy particles, estimated at ˜4.2±0.7 nm, indicating neither the original Pt/Mn/Fe ratio nor particle size changes upon deposition onto alumina.

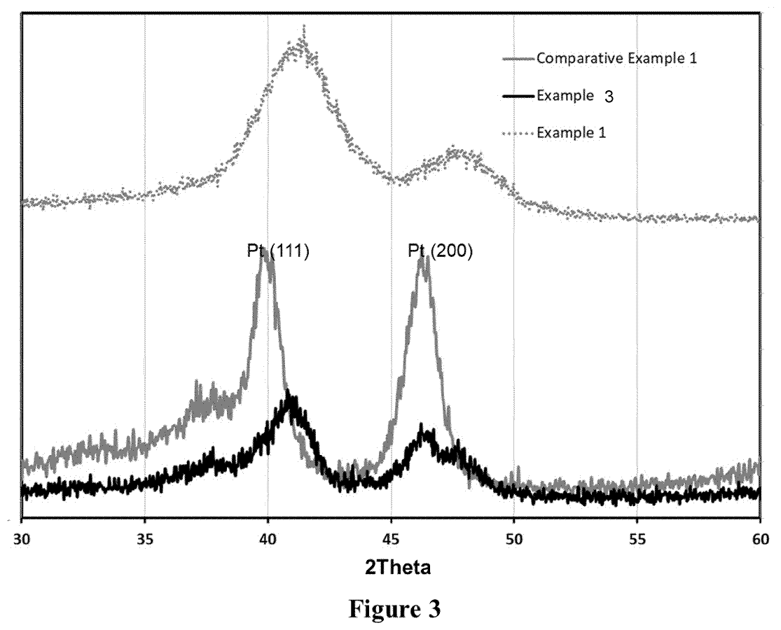

FIG. 3 shows the X-ray diffraction pattern of Example 1 (isolated PtNiCo nanoparticles), where a broad peak ˜41.4° is attributed to Pt (111), which has shifted from 39.7° for Pt-only, resulting from alloying with Ni and Co. At equal wt % Pt dispersed on alumina, Example 3 (PtNiCo/Al₂O₃) displays a Pt (111) peak at 40.8° vs Example 1 at 39.9°, indicating that alloy-structured PtNiCo particles remain unchanged.

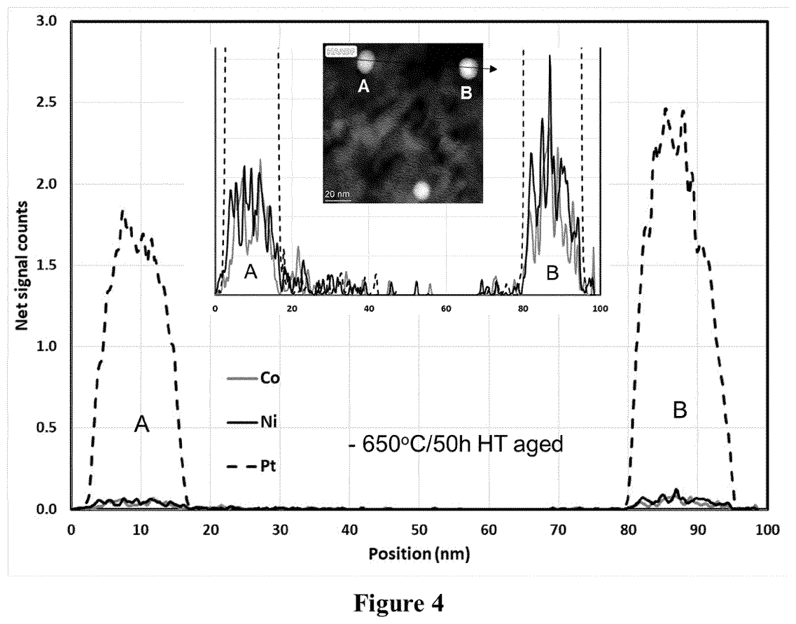

Although EDS mapping of fresh Example 3 in FIG. 1D shows enrichment of Ni and Co on the Pt particles, the resolution is severely limited due to the small particle size and low concentration of Ni and Co. The intimate Pt—Ni—Co association is more easily affirmed on a 650° C./50 h aged Example 3. FIG. 4 shows the elemental line profile across two PtNiCo particles (particle A and B) as indicated by the arrowed line in the TEM image. Each particle is now dominated by Pt signals, Ni and Co signals are consistently observed across the entire particles, although at significantly lower level than in the original PtNiCo nanoparticles (Pt₄₁Ni₃₆Co₂₃) prior to aging. The atom ratio has now changed to Pt_{96.34}/Ni_{0.56}/Co_{3.10} for particle A, and Pt_{95.90}/Ni_{1.95}/Co_{2.16} for particle B. This observation suggests that significant amount of Ni/Co separated from Pt during aging and likely was dispersed into the alumina support. The remaining trace amount of Ni and Co may continue to play crucial roles in modifying Pt chemistry. Being oxyphilic, at the particle-carrier interface, Ni and Co could help anchor ternary alloy particles more strongly to the support and slow down aging; On the particle surface, Ni and Co may promote activation of O₂ and enhance oxidation reactions.

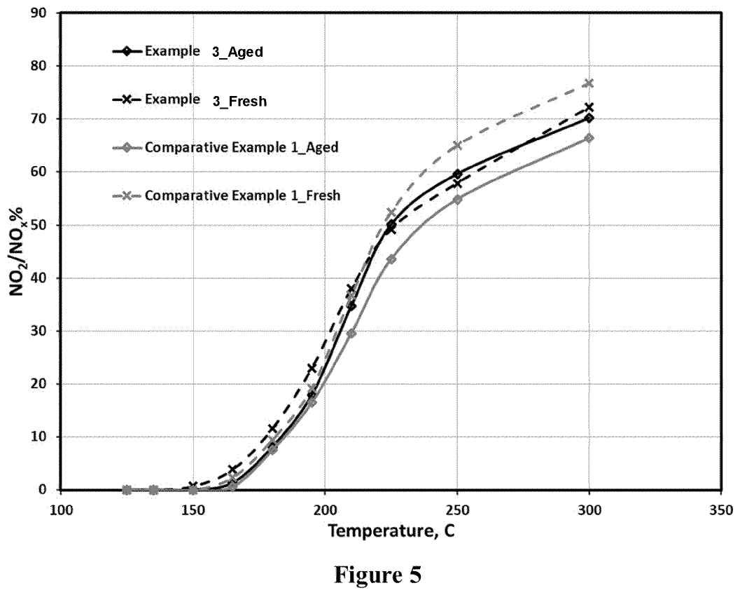

FIG. 5 compares the NO oxidation activity to NO₂ between Example 3 and Comparative Example 1 before and after aging. Although Example 3 showed lower activity in the fresh state, it remained stable after 650° C./50 h HT aging, compared to the reference., i.e., Comparative Example 1.

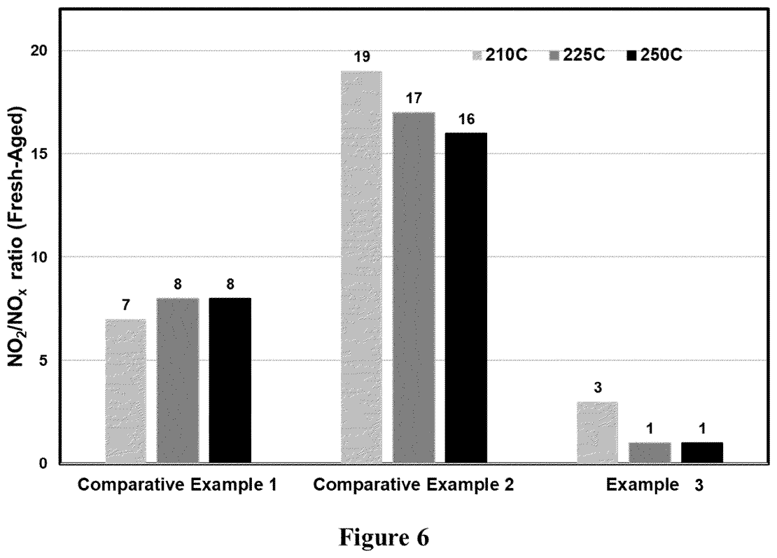

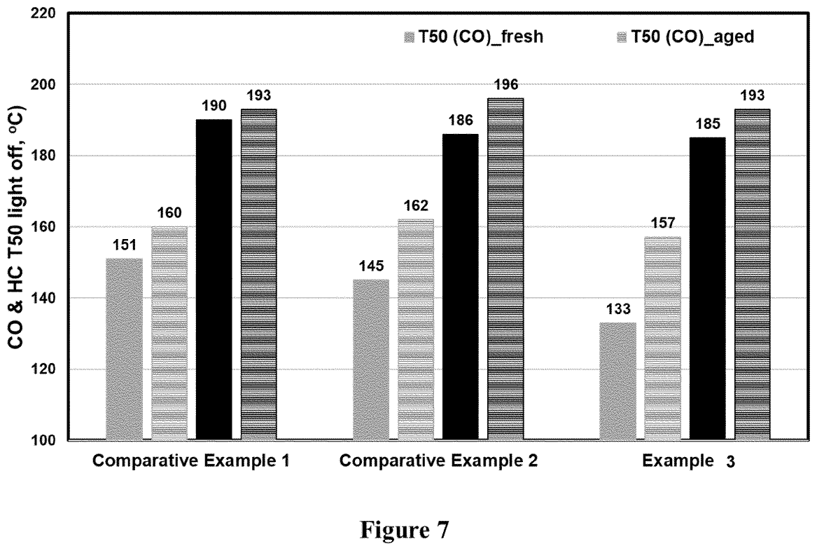

The higher stability of Example 3 is clearly demonstrated in FIG. 6, in which change in NO₂/NOₓ ratio from fresh to aged catalyst was compared at 210° C., 225° C., and 250° C., respectively. At each temperature, Example 3 showed a significantly smaller decay in activity due to aging. The largest deactivation was observed with the Comparative Example 2 in which a colloidal Pt precursor was used. Despite significant change in Pt/Ni/Co ratio and particle sintering after aging, Example 3 maintained NO oxidation activity to significant extent, implying that the remaining small amount of Ni and Co play an important role in enhancing NO oxidation. On the other hand, Example 3 showed a similar CO and HC light-off activity vs Comparative Examples 1 and 2, except that higher CO light-off activity was observed for fresh Example 3, as shown in FIG. 7. It appears that Ni/Co presence in Pt had the largest impact on maintaining NO oxidation activity after hydrothermal aging.

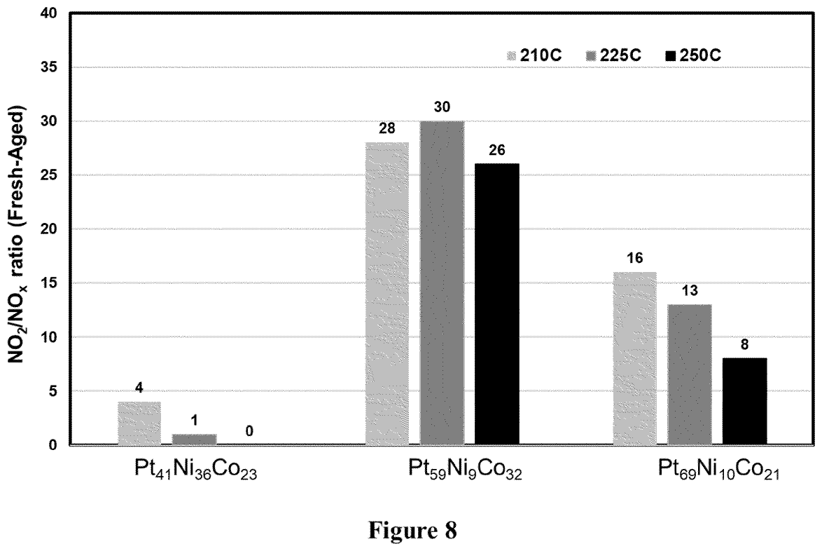

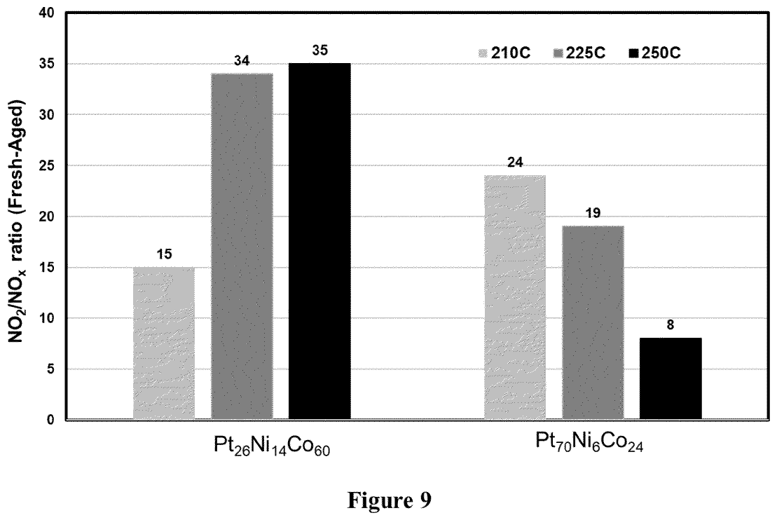

FIG. 8 and FIG. 9 show the effect of Pt atom ratio in Example 3 on the stability of NO₂ generation from fresh to aged. Here, the highest stability was achieved around intermediate Pt level ˜41%. The amount of Ni may also be a consideration, as high stability was observed when Ni was present in a similar molar amount as Co.

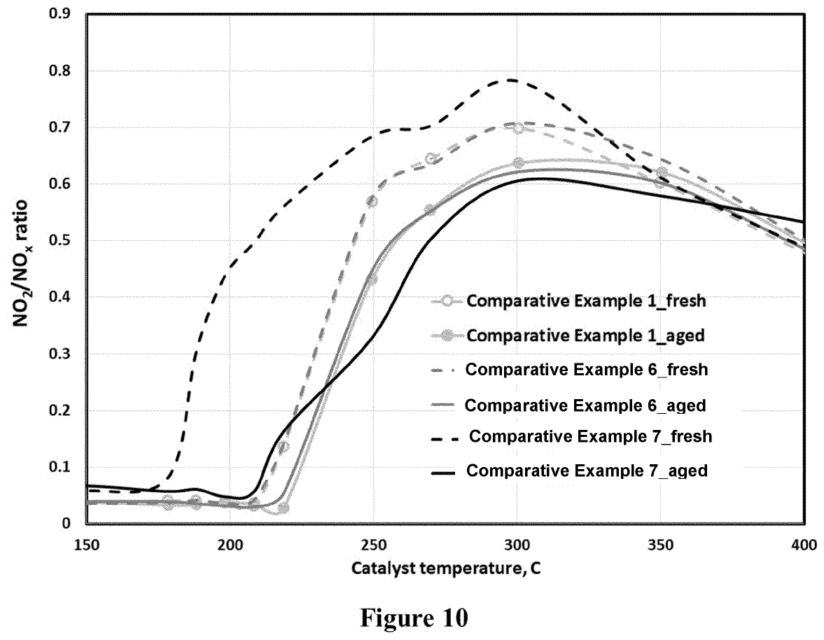

FIG. 10 shows a comparison of the activities of bimetallic alloy PtNi (Comparative Example 6) and PtCo (Comparative Example 7) supported on alumina. While Comparative Example 6 showed a similar activity as Comparative Example 1, Comparative Example 7 showed extremely high fresh activity which deteriorated severely after aging. Hence, the ternary alloy PtNiCo possesses mechanisms that enhance NO oxidation, which cannot be realized with bimetallic alloys.

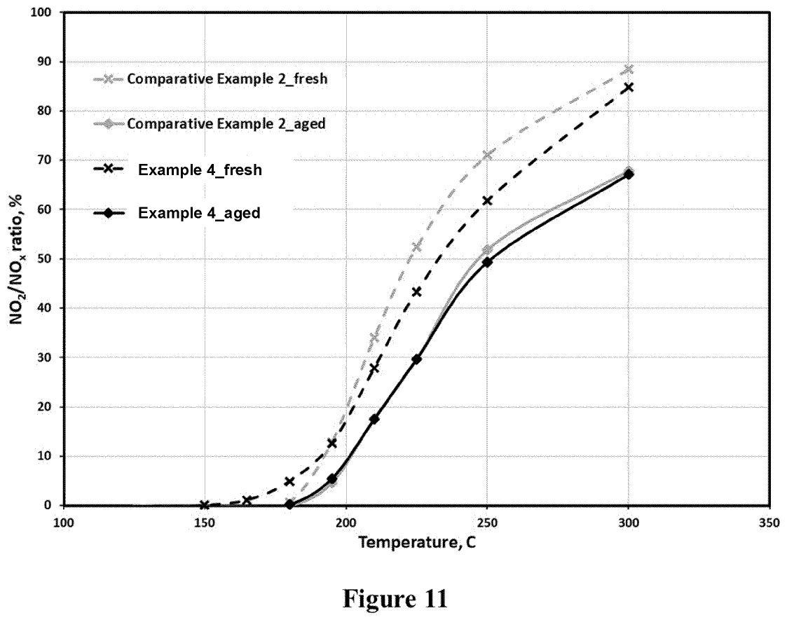

FIG. 11 shows a comparison of the activity of Example 4 (Pt₃₇Mn₅₀Fe₁₃/Al₂O₃) Vs Comparative Example 1. Example 4 showed a lower NO oxidation activity at a fresh state, and activity deteriorated to the similar level as Comparative Example 1 after aging. Characterization data (TEM and EDS) indicated that a significant phase segregation occurred after aging, resulting in Mn and Fe separating from Pt particles and integrating into the alumina support.

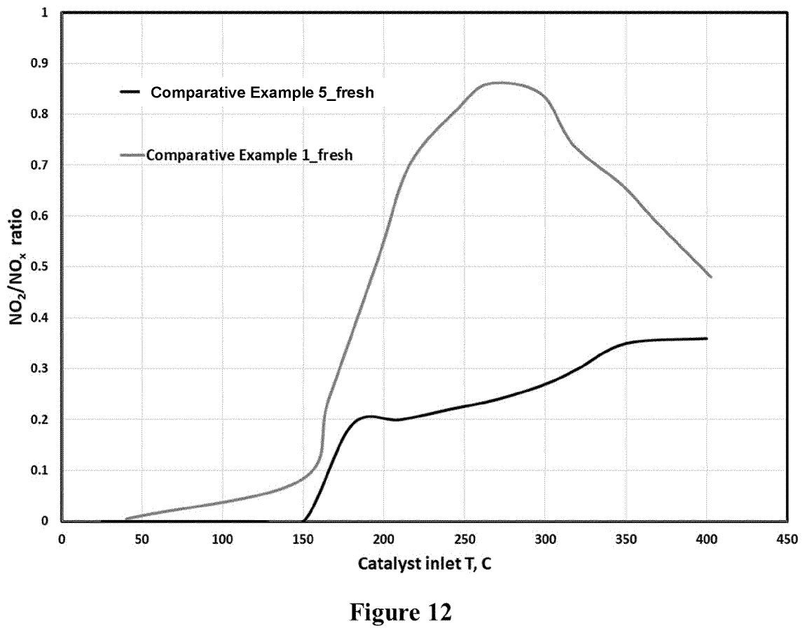

FIG. 12 shows a comparison of the fresh activity of bimetallic PtMn alloy particles supported on alumina (Comparative Example 5) vs Comparative Example 1. It appears that presence of Mn-alone in the alloy significantly decreased the NO oxidation activity. Based on the fact that ternary Pt alloy samples tend to deliver better or equal NO₂ stability, it suggests that the negative effect of a single transition metal is altered significantly in the presence of a second transition metal, leading to enhanced activity particularly in the case of PtNiCo catalysts.

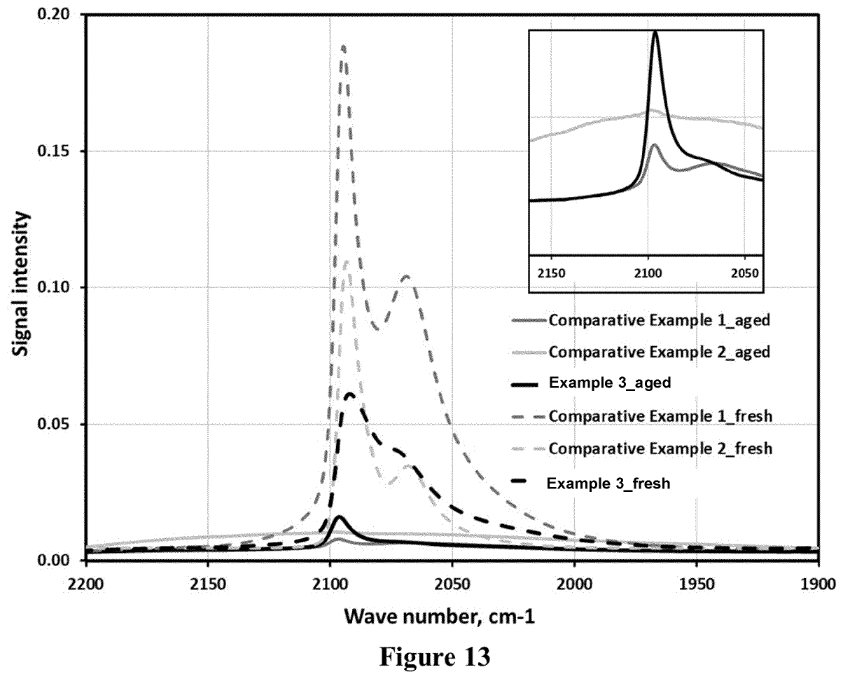

A DRIFTS (Diffuse Reflectance Infrared Fourier Transform Spectroscopy) study of CO-adsorption experiments on Comparative Examples and Example 3 shows that, prior to aging, both Comparative Examples possess higher available Pt surface for CO adsorption than Example 3. This is likely due to two factors: (1) PtNiCo alloy nanoparticle precursors have larger average particle size than the initial Pt particles obtained in the Comparative Examples; (2) ternary PtNiCo alloy nanoparticles are also found to be enriched with Ni and Co on the surface which reduces available Pt on the surface for CO adsorption. After 650° C./50 hours hydrothermal aging, although all catalysts show significantly decreased CO-adsorption intensity, the reduction in Comparative Examples 1 and 2 is much more pronounced. Example 3 now possesses the highest Pt surface available for CO-adsorption (see insert of FIG. 13), indicating that Example 3 is more resistant to hydrothermal aging, due to the presence of Ni and Co. Being oxyphilic, Ni and Co can improve the adhesion of ternary nanoalloy particles to the inorganic oxide support and hence slow down particle growth and agglomeration. On the nanoparticle surface, Ni and Co activate O₂ more efficiently and promote oxidation reaction.

### Embodiments

The present invention is further illustrated by the following set of embodiments and combinations of embodiments resulting from the dependencies and back-references as indicated. In particular, it is noted that in each instance where a range of embodiments is mentioned, for example in the context of a term such as “The catalyst of any one of embodiments 1 to 4”, every embodiment in this range is meant to be explicitly disclosed for the skilled person, i.e. the wording of this term is to be understood by the skilled person as being synonymous to “The catalyst of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A ternary alloy nanoparticle catalyst comprising a platinum group metal alloyed with at least two transition metal elements.
2. The ternary alloy nanoparticle catalyst of embodiment 1, comprising two transition metal elements.
3. The ternary alloy nanoparticle catalyst of embodiment 1, comprising three transition metal elements.
4. The ternary alloy nanoparticle catalyst of embodiment 1, comprising four transition metal elements.
5. The ternary alloy nanoparticle catalyst of any one of embodiments 1-4, wherein the platinum group metal is chosen from Pt, Pd, Ru, Rh, Ir, and Os.
6. The ternary alloy nanoparticle catalyst of any one of embodiments 1-5, wherein the platinum group metal is chosen from Pt, Pd, and Ru.
7. The ternary alloy nanoparticle catalyst of any one of embodiments 1-6, wherein the platinum group metal is chosen from Pt and Pd.
8. The ternary alloy nanoparticle catalyst of any one of embodiments 1-7, wherein the platinum group metal is a combination of Pt and Pd.
9. The ternary alloy nanoparticle catalyst of any one of embodiments 1-7, wherein the platinum group metal is Pt.
10. The ternary alloy nanoparticle catalyst of any one of embodiments 1-9, wherein the at least two transition metal elements are chosen from Ni, Co, Mn, Fe, V, Zn, Cu, Ti, Sc, and Cr.
11. The ternary alloy nanoparticle catalyst of any one of embodiments 1-10, wherein the at least two transition metal elements are chosen from Ni, Co, Mn, and Fe.
12. The ternary alloy nanoparticle catalyst of any one of embodiments 1-11, wherein the at least two transition metal elements are Ni and Co.
13. The ternary alloy nanoparticle catalyst of any one of embodiments 1-11, wherein the at least two transition metal elements are Mn and Fe.
14. The ternary alloy nanoparticle catalyst of any one of embodiments 1-13, wherein the ternary alloy nanoparticle is supported on a refractory oxide support chosen from silica, δ-alumina, θ-alumina, γ-alumina, Si-doped alumina, alkaline earth metal-stabilized alumina, transition metal-stabilized alumina, zirconia, and titania.
15. The ternary alloy nanoparticle catalyst of embodiments 14, wherein the refractory oxide support is Si-doped alumina containing SiO₂ in a range of about 1% to about 20%.
16. The ternary alloy nanoparticle catalyst of embodiment 14, wherein the refractory oxide support is Mn-stabilized alumina.
17. The ternary alloy nanoparticle catalyst of embodiment 14, wherein the refractory oxide support is Zr-doped alumina.
18. The ternary alloy nanoparticle catalyst of embodiment 14, wherein the refractory oxide support is Ti-doped alumina.
19. The ternary alloy nanoparticle catalyst of any one of embodiments 1-18, wherein the platinum group metal content of the alloy is less than or equal to about 80 atom % of the metal content.
20. The ternary alloy nanoparticle catalyst of any one of embodiments 1-19, wherein the platinum group metal content of the alloy is about 80 atom % of the metal content.
21. The ternary alloy nanoparticle catalyst of any one of embodiments 1-19, wherein the platinum group metal content of the alloy is about 70 atom % of the metal content.
22. The ternary alloy nanoparticle catalyst of any one of embodiments 1-19, wherein the platinum group metal weight ratio is about 60 atom % of the metal content.
23. The ternary alloy nanoparticle catalyst of any one of embodiments 1-19, wherein the platinum group metal content of the alloy is about 50 atom % of the metal content.
24. The ternary alloy nanoparticle catalyst of any one of embodiments 1-19, wherein the platinum group metal content of the alloy is about 40 atom % of the metal content.
25. The ternary alloy nanoparticle catalyst of any one of embodiments 1-19, wherein the platinum group metal weight ratio is about 30 atom % of the metal content.
26. The ternary alloy nanoparticle catalyst of any one of embodiments 1-19, wherein the platinum group metal content of the alloy is about 20 atom % of the metal content.
27. The ternary alloy nanoparticle catalyst of any one of embodiments 1-26, wherein the at least two transition metal elements have a combined weight ratio of about 20 atom % to about 80 atom % of the metal content.
28. The ternary alloy nanoparticle catalyst of any one of embodiments 1-27, wherein the at least two transition metal elements have a combined weight ratio of about 20 atom % of the metal content.
29. The ternary alloy nanoparticle catalyst of any one of embodiments 1-27, wherein the at least two transition metal elements have a combined weight ratio of about 30 atom % of the metal content.
30. The ternary alloy nanoparticle catalyst of any one of embodiments 1-27,wherein the at least two transition metal elements have a combined weight ratio of about 40 atom % of the metal content.
31. The ternary alloy nanoparticle catalyst of any one of embodiments 1-27, wherein the at least two transition metal elements have a combined weight ratio of about 50 atom % of the metal content.
32. The ternary alloy nanoparticle catalyst of any one of embodiments 1-27, wherein the at least two transition metal elements have a combined weight ratio of about 60 atom % of the metal content.
33. The ternary alloy nanoparticle catalyst of any one of embodiments 1-27, wherein the at least two transition metal elements have a combined weight ratio of about 70 atom % of the metal content.
34. The ternary alloy nanoparticle catalyst of any one of embodiments 1-27, wherein the at least two transition metal elements have a combined weight ratio of about 80 atom % of the metal content.
35. The ternary alloy nanoparticle catalyst of any one of embodiments 1-34, wherein the platinum group metal and the at least two transition metal elements are detectable by TEM/EDS (Transmission Electron Microscopy coupled with Energy Dispersive X-Ray Spectroscopy), X-Ray Diffractometry, or a combination thereof.
36. The ternary alloy nanoparticle catalyst of any one of embodiments 1-35, wherein the XRD exhibits 2theta values for Pt fcc (111) ranging from about 39.7° to about 42° upon incorporation of different levels of the at least two transition metals.
37. The ternary alloy nanoparticle catalyst of any one of embodiments 1-36, wherein the ternary alloy nanoparticle catalyst is PtNiCo.
38. The ternary alloy nanoparticle catalyst of embodiment 37, wherein the atomic ratio of the PtNiCo ternary alloy nanoparticle catalyst is 20%-80% Pt, 1%-50% Ni, and 5%-40% Co.
39. The ternary alloy nanoparticle catalyst of embodiment 37, wherein the atomic ratio of the PtNiCo ternary alloy nanoparticle catalyst is 30%-60% Pt, 20%-40% Ni, and 10%-30% Co.
40. The ternary alloy nanoparticle catalyst of any one of embodiments 1-36, wherein the ternary alloy nanoparticle catalyst is PtMnFe.
41. The ternary alloy nanoparticle catalyst of embodiment 40, wherein the atomic ratio of the PtMnFe ternary alloy nanoparticle catalyst is 15%-40% Pt, 10%-50% Mn, and 10%-50% Fe.
42. The ternary alloy nanoparticle catalyst of embodiment 40, wherein the atomic ratio of the PtMnFe ternary alloy nanoparticle catalyst is 30%-40% Pt, 30%-40% Mn, and 30%-40% Fe.
43. An oxidation catalyst composite for abatement of exhaust gas emissions from a lean burn engine comprising the ternary alloy nanoparticle catalyst of any one of embodiments 1 to 42, wherein preferably the lean burn engine is a lean-burn gasoline engine or a diesel engine, more preferably a diesel engine.
44. The oxidation catalyst composite of embodiment 43, wherein the oxidation catalyst composite comprises:
   a carrier substrate having a length, an inlet end and an outlet end, and
   an oxidation catalyst catalytic material comprising the ternary alloy nanoparticle catalyst,
wherein the oxidation catalyst catalytic material is provided on the carrier substrate.
45. The oxidation catalyst composite of embodiment 44, wherein the oxidation catalyst catalytic material comprises, preferably consists of, a washcoat layer comprising the ternary alloy nanoparticle catalyst.
46 The oxidation catalyst composite of embodiment 45, wherein the washcoat layer comprises a zeolite.
47. The oxidation catalyst composite of embodiment 45 or 46, wherein the washcoat layer comprises from 5 to 500 g/ft³ of platinum group metal, calculated as the element, from the ternary alloy nanoparticle catalyst, preferably from 10 to 300 g/ft³, more preferably from 20 to 200 g/ft³, more preferably from 40 to 150 g/ft³, more preferably from 60 to 120 g/ft³, more preferably from 80 to 100 g/ft³.
48. The oxidation catalyst composite of embodiment 44, wherein the oxidation catalyst catalytic material comprises, preferably consists of, a bottom washcoat layer and a top washcoat layer, wherein the bottom washcoat layer is provided on the carrier substrate and the top washcoat layer is provided on the bottom washcoat layer.
49. The oxidation catalyst composite of embodiment 48, wherein the bottom washcoat layer, the top washcoat layer, or both the bottom and the top washcoat layers comprise the ternary alloy nanoparticle catalyst.
50. The oxidation catalyst composite of embodiment 49, wherein the bottom washcoat layer or the top washcoat layer comprise the ternary alloy nanoparticle catalyst, wherein the bottom or top washcoat layer comprises from 5 to 500 g/ft³ of platinum group metal, calculated as the element, from the ternary alloy nanoparticle catalyst, preferably from 10 to 300 g/ft³, more preferably from 20 to 200 g/ft³, more preferably from 40 to 150 g/ft³, more preferably from 60 to 120 g/ft³, more preferably from 80 to 100 g/ft³.
51. The oxidation catalyst composite of embodiment 49, wherein the bottom and top washcoat layers comprise the ternary alloy nanoparticle catalyst, wherein the total amount of platinum group metal in the bottom and top washcoat layers, calculated as the element, from the ternary alloy nanoparticle catalyst comprised in the bottom and top washcoat layers is in the range of from 5 to 500 g/ft³, preferably from 10 to 300 g/ft³, more preferably from 20 to 200 g/ft³, more preferably from 40 to 150 g/ft³, more preferably from 60 to 120 g/ft³, more preferably from 80 to 100 g/ft³.
52. The oxidation catalyst composite of any one of embodiments 48 to 51, wherein the top washcoat layer or the bottom washcoat layer comprises a zeolite, wherein preferably the top washcoat layer comprises a zeolite.
53. The oxidation catalyst composite of embodiment 52, wherein the top washcoat layer comprises a zeolite and the bottom washcoat layer is substantially free of zeolite.
54. The oxidation catalyst composite of embodiment 52, wherein the bottom washcoat layer comprises a zeolite and the top washcoat layer is substantially free of zeolite.
55. The oxidation catalyst composite of any one of embodiments 45 to 54, wherein the washcoat layer or the washcoat layers comprising the ternary alloy nanoparticle catalyst is substantially free of barium, wherein preferably the washcoat layer or the washcoat layers comprising the ternary alloy nanoparticle catalyst is substantially free of alkaline earth metal.
56. The oxidation catalyst composite of any one of embodiments 44 to 55, wherein the carrier substrate is a wall-flow substrate or a flow-through substrate, preferably a flow-through substrate, more preferably a honeycomb monolith substrate.
57. A process for preparing a ternary alloy nanoparticle catalyst comprising a platinum group metal alloyed with at least two transition metal elements, the process comprising:
(a) combining a precursor of the platinum group metal and precursors of the at least two transition metal elements with a capping agent in an organic solvent to form a slurry;
(b) introducing a reducing agent to the solution to produce a colloidal suspension of the ternary alloy nanoparticle catalyst;
(c) collecting and adsorbing the ternary alloy nanoparticle catalyst onto a refractory oxide support; and
(d) drying and calcining the adsorbed ternary alloy nanoparticle catalyst and refractory oxide support.
58. The process of embodiment 57, wherein the precursor of the platinum group metal is chosen from platinum(II) acetylacetonate, chloroplatinic acid, platinum(II) hydroxysulfite acid, tetraammine platinum(II) chloride, and tetraamine platinum(II) nitrate.
59. The process of embodiment 57 or 58, wherein the precursors of the at least two transition metal elements are chosen from nickel(II) acetylacetonate and cobalt(III) acetylacetonate.
60. The process of any one of embodiments 57-59, wherein the capping agent is chosen from citric acid, polyvinylpyrrolidone, oleylamine, oleic acid, and polyethylene glycol.
61. The process of any one of embodiments 57-60, wherein the reducing agent is chosen from sodium borohydride, hydrazine, formic acid, sodium formate, and an amine-borane complex; 1, 2-hexadecanediol and oleylamine.
62. The process of any one of embodiments 57-61, wherein the refractory oxide support is chosen from silica, δ-alumina, θ-alumina, γ-alumina, Si-doped alumina, alkaline earth metal-stabilized alumina, transition metal-stabilized alumina, zirconia and titania.
63. The process of embodiment 62, wherein the refractory oxide support is Si-doped alumina contain SiO₂ in a range of about 1% to about 20%.
64 The process of embodiment 62, wherein the refractory oxide support is Mn-stabilized alumina.
65. The process of embodiment 62, wherein the refractory oxide support is Zr-doped alumina.
66. The process of embodiment 62, wherein the refractory oxide support is Ti-doped alumina.
67. The process of any one of embodiments 57-66, wherein the calcining step comprises calcining the ternary alloy nanoparticle catalyst and refractory oxide support at about 800° C. under a hydrogen atmosphere for about 2 hours, followed by heating at about 260° C. in air for about 1 hour, and heating at about 590° C. in air for about 1 hour.
68. The process of any one of embodiments 57-67, wherein the nanoparticles of the ternary alloy nanoparticle catalyst have an average particle size ranging from about 2 nm to about 10 nm.
69. The process of any one of embodiments 57-67, wherein the nanoparticles of the ternary alloy nanoparticle catalyst have an average particle size ranging from about 2 nm to about 5 nm.
70. The process of any one of embodiments 57-69, wherein the total platinum group metal content of the ternary alloy nanoparticle catalyst is about 0.1 wt % to about 5 wt % of the metal content.
71. The process of any one of embodiments 57-70,wherein the total platinum group metal content of the ternary alloy nanoparticle catalyst is about 0.5 wt % to about 2 wt % of the metal content.
72. An exhaust gas treatment system comprising the ternary alloy nanoparticle catalyst of any one of the preceding embodiments, preferably comprising an oxidation catalyst composite according to any of embodiments 57 to 70, positioned downstream of and in fluid communication with an internal combustion engine.
73. The exhaust gas treatment system of embodiment 72, wherein the internal combustion engine is a lean burn engine, preferably a lean-burn gasoline engine or a diesel engine, preferably a diesel engine.
74. The exhaust gas treatment system of embodiment 72 or 73, wherein the exhaust gas treatment system is in fluid communication with the internal combustion engine via an exhaust conduit.
75. The exhaust gas treatment system of any one of embodiments 72 to 74, wherein the exhaust gas treatment system further comprises a catalyzed soot filter and/or an SCR catalyst component containing an SCR catalyst composition, preferably a catalyzed soot filter and an SCR catalyst component containing an SCR catalyst composition.
76. The exhaust gas treatment system of embodiment 75, wherein the catalyzed soot filter and/or the SCR catalyst component are located downstream of the ternary alloy nanoparticle catalyst, preferably of the oxidation catalyst composite, wherein more preferably both the catalyzed soot filter and the SCR catalyst component are located downstream of the ternary alloy nanoparticle catalyst, preferably of the oxidation catalyst composite.
77 A method of treating an exhaust gas stream comprising hydrocarbons and/or carbon monoxide and/or NOₓ, the method comprising passing the exhaust gas stream through the ternary alloy nanoparticle catalyst of any one of the preceding embodiments or through an oxidation catalyst composite according to any of embodiments 43 to 56 or through an exhaust gas treatment system of any one of the preceding embodiments.
78. The method of embodiment of 77, wherein the exhaust gas stream comprises NOₓ, preferably carbon monoxide and NOₓ, more preferably hydrocarbons, carbon monoxide, and NOₓ.
79. Use of the temary alloy nanoparticle catalyst of any one of embodiments 1 to 42 or of the oxidation catalyst composite according to any of embodiments 43 to 56 or of the exhaust gas treatment system of any of embodiments 72 to 76 for the treatment of exhaust gas from a lean-burn gasoline engine or from a diesel engine, preferably from a diesel engine.

1. A ternary alloy nanoparticle catalyst comprising a platinum group metal alloyed with at least two transition metal elements.

2. The ternary alloy nanoparticle catalyst of claim 1, wherein the platinum group metal is chosen from Pt, Pd, Ru, Rh, Ir, and Os.

3. The ternary alloy nanoparticle catalyst of claim 1, wherein the at least two transition metal elements are chosen from Ni, Co, Mn, Fe, V, Zn, Cu, Ti, Sc, and Cr.

4. The ternary alloy nanoparticle catalyst of claim 1, wherein the ternary alloy nanoparticle is supported on a refractory oxide support chosen from silica, δ-alumina, θ-alumina, γ-alumina, Si-doped alumina, alkaline earth metal-stabilized alumina, transition metal-stabilized alumina, zirconia, and titania.

5. (canceled)

6. The ternary alloy nanoparticle catalyst of claim 1, wherein the platinum group metal weight ratio is about 30 atom % to about 50 atom % of the metal content.

7. The ternary alloy nanoparticle catalyst of claim 1, wherein the at least two transition metal elements have a combined ratio of about 20 atom % to about 80 atom % of the metal content.

8. The ternary alloy nanoparticle catalyst of claim 1, wherein the platinum group metal and the at least two transition metal elements are detectable by TEM/EDS (Transmission Electron Microscopy coupled with Energy Dispersive X-ray Spectrocopy), X-Ray Diffractometry, or a combination thereof.

9. The ternary alloy nanoparticle catalyst of claim 8, wherein the XRD exhibits 2theta values for Pt fcc (111) in the range of about 39.7° to about 42° upon incorporation of different levels of the at least two transition metals.

10. The ternary alloy nanoparticle catalyst of claim 1, wherein the ternary alloy nanoparticle catalyst is chosen from PtNiCo and PtMnFe.

11. (canceled)

12. The ternary alloy nanoparticle catalyst of claim 10, wherein the atomic ratio of the PtMnFe ternary alloy nanoparticle catalyst is about 15-40% Pt, about 10-50% Mn, and about 10-50% Fe.

13. A process for preparing a ternary alloy nanoparticle catalyst comprising a platinum group metal alloyed with at least two transition metal elements, the process comprising:
(a) combining a precursor of the platinum group metal and precursors of the at least two transition metal elements with a capping agent in an organic solvent to form a slurry;
(b) introducing a reducing agent to the solution to produce a colloidal suspension of the ternary alloy nanoparticle catalyst;
(c) collecting and adsorbing the ternary alloy nanoparticle catalyst onto a refractory oxide support; and
(d) drying and calcining the adsorbed ternary alloy nanoparticle catalyst and refractory oxide support.

14. The process of claim 13, wherein:
the precursor of the platinum group metal is chosen from platinum(II) acetylacetonate, chloroplatinic acid, platinum(II) hydroxysulfite acid, tetraammine platinum(II) chloride, and tetraamine platinum(II) nitrate;
the precursors of the at least two transition metal elements are chosen from nickel(II) acetylacetonate and cobalt(III) acetylacetonate;
the capping agent is chosen from citric acid, polyvinylpyrrolidone, oleylamine, oleic acid, and polyethylene glycol;
the reducing agent is chosen from sodium borohydride, hydrazine, formic acid, sodium formate, and an amine-borane complex; 1, 2-hexadecanediol and oleylamine, and
the refractory oxide support is chosen from silica, δ-alumina, θ-alumina, γ-alumina, Si-doped alumina, alkaline earth metal-stabilized alumina, transition metal-stabilized alumina, zirconia and titania.

15. The process of claim 13, wherein the calcining step comprises calcining the ternary alloy nanoparticle catalyst and refractory oxide support at about 800° C. under a hydrogen atmosphere for about 2 hours, followed by heating at about 260° C. in air for about 1 hour, and heating at about 590° C. in air for about 1 hour.

16. The process of claim 13, wherein the nanoparticles of the ternary alloy nanoparticle catalyst have an average particle size ranging from about 2 nm to about 10 nm.

17. The process of claim 13, wherein the total platinum group metal content of the ternary alloy nanoparticle catalyst is about 0.1 wt % to about 5 wt % of the metal content.

18. An exhaust gas treatment system comprising the ternary alloy nanoparticle catalyst of claim 1, positioned downstream of and in fluid communication with an internal combustion engine.

19. The exhaust gas treatment system of claim 18, wherein the exhaust gas treatment system is in fluid communication with the internal combustion engine via an exhaust conduit.

20. The exhaust gas treatment system of claim 18, wherein the exhaust gas treatment system further comprises a catalyzed soot filter and/or an SCR catalyst component containing an SCR catalyst composition.

21. The exhaust gas treatment system of claim 20, wherein the catalyzed soot filter and/or the SCR catalyst component are located downstream of the ternary alloy nanoparticle catalyst.

22. A method of treating an exhaust gas stream comprising hydrocarbons and/or carbon monoxide and/or NOₓ, the method comprising passing the exhaust gas stream through the ternary alloy nanoparticle catalyst or an exhaust gas treatment system of claim 1.

23-28. (canceled)
